(19) United States
(12) Patent Application Publication
(10) Pub. No.: US 2023/0048875 A1
(43) Pub. Date: Feb. 16, 2023

(54) COATING METHOD AND COATING DEVICE

(71) Applicant: Panasonic Intellectual Property Management Co., Ltd., Osaka-shi, Osaka (JP)

(72) Inventors: Shinji Mino, Osaka (JP); Eisuke Sato, Osaka (JP); Takanori Maruo, Osaka (JP)

(73) Assignee: Panasonic Intellectual Property Management Co., Ltd., Osaka-shi, Osaka (JP)

(21) Appl. No.: 17/792,875

(22) PCT Filed: Nov. 17, 2020
(86) PCT No.: PCT/JP2020/042736

§ 371 Date: Jul. 14, 2022

(30) Foreign Application Priority Data
Jan. 17, 2020 (JP) 2020-006130

(51) Int. Cl. H01M 4/04; B01F 27/051; H01M 4/62

(52) U.S. Cl. CPC H01M 4/0404; B01F 27/051; H01M 4/62

(57) ABSTRACT

A coating method has: a first step for mixing an active material, a binding agent, and a solvent, and obtaining a mixed slurry; a second step for adding an additive to the mixed slurry, stirring the mixed slurry and the additive, and obtaining a coating slurry and a third step for intermittently coating the coating slurry on a collector body, and forming a coated part and a non-coated part. In the second step, the addition amount of the additive is set in accordance with a preset coating speed of the coating slurry, or the weight of the coated part, and the additive includes castor oil, cellulose nanofibers, modified silicone, an amide, polyethylene oxide, propylene glycol monomethyl ether acetate, polyamine, and/or polycarboxylic acid.

### TECHNICAL FIELD

The present disclosure relates to a coating method and a coating apparatus.

### BACKGROUND

An electrode used in batteries such as a lithium ion secondary battery includes a current collector and an active material layer formed on the current collector. The electrode is produced by applying a slurry containing an active material onto a current collector. As a method of applying the slurry to the current collector, a method of intermittently applying the slurry to the current collector to form a coated part and a non-coated part is known.

However, when the process of supplying the slurry to the current collector to form the coated part shifts to the process of stopping the supply of the slurry to the current collector to form the non-coated part, the trace of stringing (hereinafter, string trace) of the slurry is formed at the coating end of the coated part. If the string trace is long, the battery capacity may be reduced. In addition, for example, a lead to be connected to a terminal of the battery is welded to the non-coated part, and thus welding of the lead may be difficult due to a long string trace.

For example, Patent Literature 1 discloses a coating apparatus for forming a coated part and a non-coated part on a substrate, in which a vibration generator is attached to a lip tip of a coating head that discharges a slurry to the substrate. Patent Literature 1 states that the vibration generator vibrates the lip tip of the coating head at a desired frequency, so that the drainability of the coating liquid discharged from the lip tip can be enhanced, and the string trace formed at the coating end of the coated part formed on the substrate can be suppressed.

### CITATION LIST

### Patent Literature

Patent Literature 1: JP 2014-176824 A

### SUMMARY

The length of the stringing at the coating end is affected by the coating speed of the slurry and the basis weight of the coated part. In the conventional art, stringing at the coating end may not be sufficiently suppressed depending on the conditions of the coating speed of the slurry and the basis weight of the coated part.

A coating method according to an aspect of the present disclosure includes: a first step of kneading an active material, a binder, and a solvent to obtain a kneaded slurry; a second step of adding an additive to the kneaded slurry and stirring the kneaded slurry and the additive to obtain a coating slurry; and a third step of intermittently applying the coating slurry onto a current collector to form a coated part and a non-coated part, wherein in the second step, an addition amount of the additive is set in accordance with a coating speed of the coating slurry or a basis weight of the coated part set in advance, and the additive contains at least one of castor oil, cellulose nanofibers, modified silicone, an amide, polyethylene oxide, propylene glycol monomethyl ether acetate, polyamine, and polycarboxylic acid.

A coating apparatus according to an aspect of the present disclosure includes: a kneading unit that kneads an active material, a binder, and a solvent to provide a kneaded slurry, a stirring unit that stirs the kneaded slurry and the additive to provide a coating slurry, the stirring unit including an adding unit that adds an additive to the kneaded slurry; and a coating unit that intermittently applies the coating slurry onto a current collector to form a coated part and a non-coated part, wherein the stirring unit includes a controller that sets an addition amount of the additive to be added by the adding unit according to a coating speed of the coating slurry or a basis weight of the coated part set in advance, and the additive contains at least one of castor oil, cellulose nanofibers, modified silicone, an amide, polyethylene oxide, propylene glycol monomethyl ether acetate, polyamine, and polycarboxylic acid.

According to the present disclosure, in intermittent coating of a slurry containing an active material, it is possible to suppress stringing at the coating end.

### BRIEF DESCRIPTION OF DRAWINGS

FIG. 1 is a schematic view illustrating an example of a configuration of a coating apparatus according to the present embodiment.

FIG. 2 is a schematic view illustrating a state in which a coating slurry is applied on a current collector.

### DESCRIPTION OF EMBODIMENTS

Hereinafter, embodiments of the present disclosure will be described with reference to the drawings.

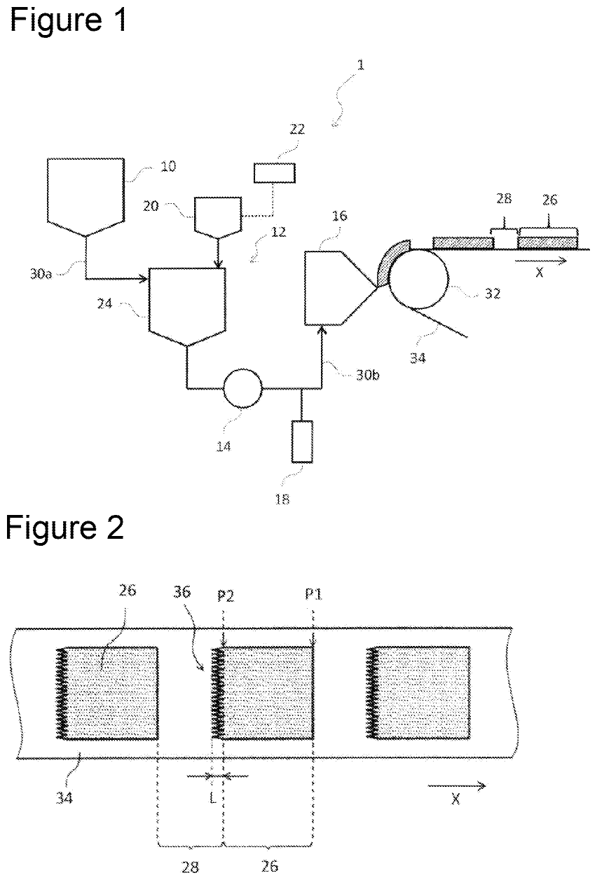

FIG. 1 is a schematic view illustrating an example of a configuration of a coating apparatus according to the present embodiment. A coating apparatus 1 illustrated in FIG. 1 includes a kneader 10 as a kneading unit, a stirring device 12 as a stirring unit, a liquid feeder 14, a coating head 16 as a coating unit, and an intermittent mechanism 18. Although the specific operation of the coating apparatus 1 will be described later, a coated product in which a coated part 26 coated with a coating slurry and a non-coated part 28 not coated with a coating slurry are formed on a current collector 34 as illustrated in FIG. 1 can be obtained by the coating apparatus 1.

The kneader 10 kneads an active material, a binder, and a solvent to provide a kneaded slurry. Kneading by the kneader 10 is performed by, for example, a mixing method in which raw materials are subdivided and dispersed by strong shearing. As the kneader 10, a known kneader can be employed, and a batch kneader such as a Banbury mixer or a pressure kneader in which two rotor blades in a container rotate, or a twin-screw planetary mixing kneader in which two blades simultaneously revolute and rotate can be used, for example. Alternatively, a single-screw kneading extruder, a continuous screw kneader such as a twin-screw kneading extruder, a spiral mixer such as a kneader using a rotor having a pin, or FILMIX in which a slurry is confined in a thin film formed by centrifugal force through high-speed rotating and kneaded may be used, for example.

The stirring device 12 includes an additive feeder 20 as an adding unit, a controller 22, and a stirrer 24. The additive feeder 20 is electrically connected to the controller 22, and supplies the additive to the stirrer 24 based on information of the addition amount transmitted from the controller 22.

The additive is a stringing inhibitor described later that suppresses stringing at the coating end and contains at least one of castor oil, cellulose nanofibers, modified silicone, an amide, polyethylene oxide, propylene glycol monomethyl ether acetate, polyamine, and polycarboxylic acid.

The controller 22 sets the addition amount of the additive. The controller 22 is, for example, an integrated circuit (IC) chip including a computer that includes a processor such as a central processing unit (CPU) and operates according to a control program, and an IC chip of an application specific integrated circuit (ASIC). The controller 22 stores, for example, a map that defines the relationship between the coating speed of the coating slurry and the addition amount of the additive, a map that defines the relationship between the basis weight of the coated part 26 and the addition amount of the additive, or the like.

The controller 22 may store a table, a functional formula, or the like that defines the relationship between the coating speed of the coating slurry or the basis weight of the coated part 26, and the addition amount of the additive. The map is created in advance based on an experiment or the like. In general, as the coating speed increases, or the basis weight of the coated part 26 increases, the length of the string trace at the coating end of the coated part 26 increases. Therefore, in order to obtain the effect of suppressing stringing, in the map, for example, the addition amount of the additive also increases according to an increase in the coating speed or an increase in the basis weight of the coated part 26.

The stirrer 24 mixes the kneaded slurry and the additive to provide a coating slurry. Stirring by the stirrer 24 is performed by, for example, a stirring method of causing a circulating flow of raw materials by shearing weaker than that of the kneader 10 and uniformly mixing the raw materials. As the stirrer 24, a known stirrer can be employed, and a magnetic stirrer, a three-one motor, a homogenizer, a media mill, a colloid mill, a homomixer, a homodisper, a planetary mixer, an in-line mixer, or a pipeline mixer can be used, for example.

The liquid feeder 14 feeds the coating slurry to the coating head 16, and is, for example, a pump.

A so-called slot die is generally used as the coating head 16, and the coating slurry is discharged from a slit having a predetermined width. As the slit, a slit formed by a method of sandwiching a plate called a shim having a necessary thickness between an upstream head and a downstream head is common. In addition, a liquid reservoir called a manifold is provided on the side of the upstream head, and coating is generally performed by discharging the coating slurry through the liquid reservoir.

The intermittent mechanism 18 is described as an example of a coating liquid suction method, for example, but is not limited to this method. For example, the intermittent mechanism 18 intermittently sucks the coating slurry to be supplied to the coating head 16 to instantaneously bring the pressure in the coating head 16 into a negative pressure state. As a result, the coating slurry is intermittently discharged from the coating head 16, and the coated part 26 and the non-coated part 28 are formed.

An example of the operation of the coating apparatus 1 according to the present embodiment will be described.

The active material, the binder, and the solvent are charged into the kneader 10 and kneaded by the kneader 10, and a kneaded slurry is obtained (first step). The obtained kneaded slurry is supplied to the stirrer 24 via a flow path 30a. Here, the controller 22 searches a map that defines the relationship between the coating speed of the coating slurry and the addition amount of the coating slurry or a map that defines the relationship between the basis weight of the coated part 26 and the addition amount of the additive using a coating speed of the coating slurry or basis weight of the coated part 26 set in advance, as a key, and obtains the addition amount of the additive corresponding to the coating speed of the coating slurry or the basis weight of the coated part 26 set in advance.

The coating speed of the coating slurry or basis weight of the coated part 26 set in advance is a coating condition set by an operator or the like when the apparatus is operated. The operator inputs the coating speed of the coating slurry and the basis weight of the coated part 26 from an input device. Then, the input information of the coating speed of the coating slurry or the basis weight of the coated part 26 is transmitted to the controller 22. Alternatively, the operator inputs coating conditions such as the rotational speed of a roll 32 and the discharge amount in the coating head 16 from the input device. In this case, for example, information of the input coating conditions is transmitted to the controller 22, and the controller 22 calculates the coating speed of the coating slurry or the basis weight of the coated part 26 from the coating conditions such as the rotational speed of the roll 32 and the discharge amount in the coating head 16.

The controller 22 transmits information of the addition amount of the additive corresponding to the coating speed of the coating slurry or basis weight of the coated part 26 set in advance to the additive feeder 20. The additive feeder 20 supplies the additive to the stirrer 24 based on the received information of the addition amount of the additive. Then, the stirrer 24 stirs the kneaded slurry and the additive to provide a coating slurry (second step).

The coating slurry obtained by the stirrer 24 is supplied to the coating head 16 via a flow path 30b by the liquid feeder 14. Then, the roll 32 rotates at a set rotational speed, and the coating slurry is discharged from the coating head 16 to the current collector 34 at a set discharge amount while the band-shaped current collector 34 is conveyed in the X direction. In addition, the intermittent mechanism 18 operates periodically, and the discharge of the coating slurry from the coating head 16 is stopped. In this manner, the coating slurry is intermittently applied to the current collector 34, and the coated part 26 and the non-coated part 28 (third step) are formed.

FIG. 2 is a schematic view illustrating a state in which the coating slurry is applied onto the current collector. As illustrated in FIG. 2, by intermittently applying the coating slurry onto the current collector 34, a plurality of coated parts 26 and non-coated parts 28 are alternately formed on the current collector 34. The coated part 26 refers to a region from a coating start end P1 to a coating end P2. In addition, the non-coated part 28 is later used for welding of the lead, cutting for each electrode of one battery, and the like.

Normally, even if the discharge of the coating slurry from the coating head 16 is stopped, the coating slurry is elongated from the coating head 16 due to the surface tension of the coating slurry. As a result, the coating slurry was elongated from the coating end P2 toward the non-coated part 28 along the conveying direction X, and a string trace 36 is likely to be formed. If the length L of the string trace 36 is large, lead welding failure may occur in the non-coated part 28, or a decrease in the capacity of the battery may be caused.

However, in the present disclosure, the coating slurry contains the specific additives described above. Thus, stringing at the coating end P2 can be suppressed. As described above, stringing at the coating end P2 is affected by the coating speed and the basis weight of the coated part 26. Specifically, as the coating speed increases, or the basis weight of the coated part 26 increases, the length L of the string trace 36 increases. Therefore, in order to provide a coating slurry having an effect of suppressing stringing at any coating speed or basis weight, it is conceivable to include an excessive amount of the additive in the coating slurry, for example. In that case, there is a possibility that the production cost of the battery increases or the battery performance deteriorates, for example. However, in the present disclosure, an optimum amount of the additive can be added according to the coating speed of the coating slurry and the basis weight of the coated part 26. It is therefore possible to provide a coating slurry having an effect of suppressing stringing at any coating speed or basis weight, and an effect of suppressing the production cost of the battery and deterioration of the battery performance can be expected.

In addition, in battery production, a plurality of coating lines having different coating speeds and different basis weights of the coated part 26 may be provided in accordance with the capacity, size, and the like of the battery. As in the present disclosure, the process is divided into a first step of obtaining the kneaded slurry and a second step of adding an optimum amount of the additive to the kneaded slurry according to the coating speed of the coating slurry and the basis weight of the coated part 26. As a result, the kneaded slurry obtained in the first step can be divided into small portions, and the second step can be performed on each of the divided kneaded slurries, for example. This also makes it possible to prepare a plurality of coating slurries suitable for the coating speed and the basis weight of the coated part 26 for each of the plurality of coating lines and supply the coating slurry to each coating line.

The coated product in which the coated part 26 and the non-coated part 28 are formed on the current collector 34 is dried and rolled as necessary, and applied to the electrode of the battery.

Hereinafter, materials of the additive, the active material, the binder, the solvent, the current collector 34, and the like will be described in detail.

The additive is castor oil, cellulose nanofibers, modified silicone, an amide, polyethylene oxide, propylene monomethyl ether acetate, polyamine, or polycarboxylic acid described above. Among them, cellulose nanofibers and polyethylene oxide are preferable, which have a high effect of suppressing stringing at the coating end P2. The additive is added mainly in the second step, but the addition in the first step is not limited. That is, the additive may be added in the first step and the second step. The polyethylene oxide refers to polyethylene having a carboxyl group (—COOH) at a terminal thereof. The castor oil may be hydrogenated castor oil.

The additive preferably contains cellulose nanofibers, and the cellulose nanofibers preferably contain lignocellulose. When the additive contains lignocellulose, the additive is close to lipophilic, and for example, the dispersibility of the additive in the organic solvent-based coating slurry is improved.

When cellulose nanofibers are contained as an additive, it is preferable to contain 50% or more (relative particle amount based on 100% as a whole) of cellulose particles having a number average width of the short width of 3 to 100 nm, an aspect ratio of 40 or more, and a number average width of the long width of 100 μm or more. Thus, for example, stringing at the coating end P2 can be more effectively suppressed.

The number average width can be measured by the following method. First, an aqueous dispersion of cellulose nanofibers having a solid content of 0.05 to 0.1 mass % is prepared. The dispersion is cast on a hydrophilized carbon film-coated grid to obtain a sample for observation with a transmission electron microscope (TEM). Then, observation with an electron microscope image is performed at a magnification of 5,000 times, 10.000 times, or 50,000 times depending on the size of constituting fibers. At this time, any two axes with a width of the image are assumed in the vertical direction and the horizontal direction of the obtained image. The sample and observation conditions (magnification and the like) are adjusted so that 20 or more fibers intersect each axis. After an observation image satisfying the conditions is obtained, two axes are randomly drawn in each of the vertical direction and horizontal direction per image, and the widths of the fibers intersecting each axis are visually read. In this way, at least three images of non-overlapping surface portions are taken with an electron microscope. The values of widths of fibers intersecting with each of the two axes are read (therefore, information of widths of at least 120 (20×2×3) fibers is obtained). From the data of the number average width of the fibers thus obtained, the number average widths of the short width and the long width are calculated.

The aspect ratio of the cellulose nanofiber is calculated according to the following equation (1) using the number average width of the short width and the number average width of the long width calculated as described above.

Aspect ratio=number average width of long width % number average width of short width (1)

The additive contains cellulose nanofibers, and the cellulose nanofibers are preferably contained in an amount of 0.01 mass % to 0.2 mass % based on 100 mass % of the solid content of the coating slurry. This suppresses an increase in viscosity of the coating slurry and facilitates intermittent coating, for example.

The active material is appropriately selected depending on the type of battery or electrode to which the coated product is applied. Examples thereof include a lithium-transition metal composite oxide in the case of a positive electrode of a lithium ion secondary battery. Specific examples thereof include lithium cobalt oxide, lithium manganese oxide, lithium nickel oxide, lithium nickel manganese composite oxide, and lithium nickel cobalt composite oxide. In addition, Al, Ti, Zr, Nb, B, W, Mg, Mo, or the like may be added to these lithium-transition metal composite oxides. In addition, in the case of a negative electrode of a lithium ion secondary battery, for example, a carbon material or a non-carbon material capable of occluding and releasing lithium ions can be exemplified. Examples of the carbon material include graphite, non-graphitizable carbon, graphitizable carbon, fibrous carbon, and coke. Examples of the non-carbon-based material include silicon, tin, and alloys and oxides mainly containing these substances.

The binder is not particularly limited as long as it is a substance that ensures the binding property between the coated part 26 and the current collector 34. Examples thereof include fluorine-based resins such as polytetrafluoroethylene (PTFE) and polyvinylidene fluoride (PVdF), polyacrylonitrile (PAN), polyimide-based resins, acrylic resins, polyolefin-based resins, styrene-butadiene rubber (SBR), nitrile-butadiene rubber (NBR), carboxymethyl cellulose (CMC) or salts thereof, polyacrylic acid (PAA) or salts thereof (PAA-Na, PAA-K, and the like, and partially neutralized salts may be used), and polyvinyl alcohol (PVA).

The solvent is not particularly limited as long as it disperses the active material and the binder, and examples thereof include water, alcohol, and N-methyl-2-pyrrolidone (NMP).

The current collector 34 is appropriately selected depending on the type of battery or electrode to which the coated product is applied. In the case of a positive electrode of a lithium ion secondary battery, a foil of a metal stable within a potential range of the positive electrode, such as aluminum, a film in which such a metal is disposed on a surface layer thereof, and the like are exemplified. In addition, in the case of a negative electrode of a lithium ion secondary battery, for example, a foil of a metal stable within a potential range of the negative electrode, such as copper, a film in which such a metal is disposed on a surface layer thereof, and the like are exemplified.

The kneaded slurry and the coating slurry may contain a filler that imparts an additional function to the coated part 26. Examples of the filler include a conductive agent for enhancing conductivity of the coated part 26. Examples of the conductive agent include carbon black, acetylene black, and Ketjen black.

### Experimental Example 1

A lithium-transition metal composite oxide as a positive electrode active material, acetylene black as a conductive agent, and polyvinylidene fluoride as a binder were mixed at a mass ratio of 98:1:1. An appropriate amount of N-methyl-2-pyrrolidone as a solvent was further added, and the mixture was kneaded by a kneader (HIVIS DISPER MIX 3D-2, manufactured by PRIMIX Corporation) to obtain a kneaded slurry.

To 500 L of the kneaded slurry 0.1 mass % of cellulose nanofibers (manufactured by Mori Machinery Corporation. L100) was added, and the mixture was stirred with a stirrer (Homodisper model 2.5, manufactured by PRIMLX Corporation) to obtain a coating slurry.

As illustrated in FIG. 1, the coating slurry was intermittently discharged from the coating head while the roll was rotated to convey an aluminum foil as a current collector in the conveying direction X. and a coated part and a non-coated part are formed on the aluminum foil. As coating conditions, the coating speed of the coating slurry was set to 40 n/nmn, and the basis weight of the coated part was set to 200 g/m². Then, coating was performed so that the length of the coated part in the conveying direction X was 200 mm and the length of the non-coated part in the conveying direction X was 10 mm.

### Experimental Example 2

Intermittent coating was performed in the same manner as in Experimental Example 1 except that polyethylene oxide (ET4010, manufactured by Kusumoto Chemicals, Ltd.) was added instead of the cellulose nanofibers.

### Experimental Example 3

Intermittent coating was performed in the same manner as in Experimental Example 1 except that amide (ET2020, manufactured by Kusumoto Chemicals, Ltd.) was added instead of the cellulose nanofibers.

### Experimental Example 4

Intermittent coating was performed in the same manner as in Experimental Example 1 except that castor oil (RM1920, manufactured by BASF SE) was added instead of the cellulose nanofibers.

### Experimental Example 5

Intermittent coating was performed in the same manner as in Experimental Example 1 except that no cellulose nanofiber was added.

For Experimental Examples 1 to 5, the length of the string trace at the coating end was obtained. Specifically, three coated parts were freely selected from the plurality of intermittently formed coated parts, the lengths of the string traces at the coating end in the selected three coated parts were measured, the average value thereof was obtained, and the average value was taken as the length L of the string trace. The length of the string trace at the coating end in the three coated parts is an average value of the lengths of the plurality of string traces formed at each coating end.

When the length L of the string trace of Experimental Example 5 was set to 100 and the length L of the string trace of Experimental Example 1 was expressed as a relative value, the value was 45. That is, addition of the cellulose nanofibers shortened the length of the string trace at the coating end. Similarly, the value was 50 for polyethylene oxide of Experimental Example 2, 67 for amide of Experimental Example 3, and 77 for castor oil of Experimental Example 4. In addition, coating slurries, to which modified silicone, propylene glycol monomethyl ether acetate, polyamine, and polycarboxylic acid were respectively added, were prepared, and intermittent coating was performed in the same manner as in Experimental Example 1. As a result, the length of the string trace in any of the above cases was shorter than the length L of the string trace of Experimental Example 5.

### REFERENCE SIGNS LIST

1 Coating apparatus
10 Kneader
12 Stirring device
14 Liquid feeder
16 Coating head
18 Intermittent mechanism
20 Additive feeder
22 Controller
24 Stirrer
26 Coated part
28 Non-coated part
30a, 30b Flow path
32 Roll
34 Current collector
36 String trace
P1 Coating start end
P2 Coating end
X Conveying direction

1. A coating method comprising:
a first step of kneading an active material, a binder, and a solvent to obtain a kneaded slurry;
a second step of adding an additive to the kneaded slimy and stirring the kneaded slurry and the additive to obtain a coating slurry; and
a third step of intermittently applying the coating slurry onto a current collector to form a coated part and a non-coated part, wherein
in the second step, an addition amount of the additive is set in accordance with a coating speed of the coating slurry or a basis weight of the coated part set in advance, and
the additive contains at least one of castor oil, cellulose nanofibers, modified silicone, an amide, polyethylene oxide, propylene glycol monomethyl ether acetate, polyamine, and polycarboxylic acid.

2. The coating method according to claim 1, wherein the additive contains the cellulose nanofibers, and the cellulose nanofibers contain lignocellulose.

3. The coating method according to claim 1, wherein the additive contains the cellulose nanofibers, and the cellulose nanofibers contain 50% or more (relative particle amount based on 100% as a whole) of particles having a number average width of a short width of 3 to 100 nm, an aspect ratio of 40 or more, and a number average width of a long width of 100 μm or more.

4. The coating method according to claim 1, wherein the additive contains the cellulose nanofibers, and the cellulose nanofibers are contained in an amount of 0.01 mass % to 0.2 mass % based on 100 mass % of a solid content of the coating slurry.

5. A coating apparatus, comprising:
a kneading unit that kneads an active material, a binder, and a solvent to provide a kneaded slurry;
a stirring unit that stirs the kneaded slurry and the additive to provide a coating slurry, the stirring unit including an adding unit that adds an additive to the kneaded slurry; and
a coating unit that intermittently applies the coating slurry onto a current collector to form a coated part and a non-coated part, wherein
the stirring unit includes a controller that sets an addition amount of the additive to be added by the adding unit according to a coating speed of the coating slurry or a basis weight of the coated part set in advance, and
the additive contains at least one of castor oil, cellulose nanofibers, modified silicone, an amide, polyethylene oxide, propylene glycol monomethyl ether acetate, polyamine, and polycarboxylic acid.
